(19) United States
(12) Patent Application Publication
(10) Pub. No.: US 2026/0362158 A1
(43) Pub. Date: Nov. 12, 2026

(54) AUTOMATIC DISCOVERY, CONFIGURATION, AND REGISTRATION OF CITIZENS BROADBAND RADIO SERVICE (CBRS) REPEATERS

(71) Applicant: Charter Communications Operating, LLC, St. Louis, MO (US)

(72) Inventor: Saran Khalid, Denver, CO (US)

(73) Assignee: Charter Communications Operating, LLC, St. Louis, MO (US)

(21) Appl. No.: 19/201,359

(22) Filed: May 7, 2025

(51) Int. Cl. H04W 16/26; H04W 8/00; H04W 60/04

(52) U.S. Cl. CPC H04W 16/26; H04W 8/005; H04W 60/04

(57) ABSTRACT

Systems and methods which provide automatic discovery, configuration, and registration of Citizens Broadband Radio Service (CBRS) repeaters. A method includes discovering, by a base station, the repeater within a wireless coverage area of a base station, wherein the repeater is configured to extend the wireless coverage area of the base station, configuring, by a repeater register via the base station, the repeater with configuration information, provisioning, by an operations support system, the repeater upon the repeater completing application of the configuration information, and registering, by the repeater register, the repeater with a spectrum access system to enable repeater transmissions upon completion of the provisioning, wherein the base station performs as a wireless backhaul.

### TECHNICAL FIELD

This disclosure relates to communications. More specifically, maintenance of active communications sessions in the event of channel grant suspension.

### BACKGROUND

Wireless network operators or service providers can operate with or use multiple carriers to provide coverage and capacity for communications between devices. These multiple carriers can use licensed radio frequency spectrum for third generation (3G), fourth generation (4G), and fifth generation (5G) wireless communications, and unlicensed spectrum. Citizens Broadband Radio Service (CBRS) spectrum is a type of unlicensed spectrum or shared radio frequency spectrum which is shared between multiple entities including government users (such as the military), licensed users, and non-licensed users. CBRS is a multitiered wireless band between 3550 MHz and 3700 MHz. In particular, CBRS is a three-tiered access framework including incumbent users (i.e., federal, military, and the like), priority access users (winning auction bidders) who have Priority Access Licenses (PALs) to CBRS spectrum, and general authorized access (GAA) users, where the general users are permitted to use any portion of the CBRS spectrum not assigned to a higher tier user and may also operate opportunistically on unused priority access spectrum. Availability of CBRS spectrum dynamically changes depending on use by higher priority entities. Higher tier users are protected from lower tier users using a centralized spectrum access system (SAS), which may be a federal or commercial entity. The SAS authorizes or grants spectrum to access points known as CBRS Devices (CBSDs) and performs interference management to protect higher tier users. This protection may include, for example, dropping CBSDs which are general authorized access users. In summary, CBRS is an interference limited network which means that the performance of the network and the data sent to CBRS subscribers is limited by the amount of interference the CBRS users or subscribers experience in the frequency band of operation.

Service providers, which operate as a hybrid mobile network operator (HMNO), deploy CBRS 5G networks to maximize offload opportunities from usage of licensed wireless networks and minimize licensing fees. Relay nodes, relays, repeater, and/or extender devices (collectively referred to herein as a “repeater”) are used to extend coverage, complement coverage, and capacity of the wireless network. A repeater receives a wireless transmission or signal from a parent base station, processes the signal, and retransmits the signal. The processing of the signal can include, but is not limited to, signal correction, signal quality, and signal amplification (i.e., increased power level). Each repeater has to be registered with the SAS when the repeater is used with the CBRS spectrum. This can include one or more truck rolls with a certified professional installer to a customer premises to determine coverage issues, obtain repeaters, install repeaters, and register the repeaters with the SAS. This can be cumbersome and inefficient as the number of repeaters increase to provide wireless coverage. Moreover, it can be expensive to run backhaul to connect the repeater(s). In these cases, the sites are not financially feasible.

### SUMMARY

Disclosed herein is a method for automatic discovery, configuration, and registration of Citizens Broadband Radio Service (CBRS) repeaters. In implementations, the method includes discovering, by a base station, the repeater within a wireless coverage area of a base station, wherein the repeater is configured to extend the wireless coverage area of the base station, configuring, by a repeater register via the base station, the repeater with configuration information, provisioning, by an operations support system, the repeater upon the repeater completing application of the configuration information, and registering, by the repeater register, the repeater with a spectrum access system to enable repeater transmissions upon completion of the provisioning, where the base station performs as a wireless backhaul.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a wireless network in accordance with embodiments of this disclosure.

FIG. 2 is a diagram of an example of a wireless network architecture in accordance with embodiments of this disclosure.

FIG. 2A is a diagram of SAS registration parameters in accordance with embodiments of this disclosure.

FIG. 3 is a flow diagram of an example automated repeater registration flow in accordance with the teachings described herein.

FIG. 3A is a diagram of an object for SAS registration in accordance with embodiments of this disclosure.

FIG. 4 is a flowchart of an example method for automated repeater registration in accordance with the teachings described herein.

FIG. 5 is a block diagram of an example of a device in accordance with the teachings described herein.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers – a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described teachings and/or embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed teachings and/or embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein are methods and systems for automated or automatic discovery, configuration, and registration of Citizens Broadband Radio Service (CBRS) repeaters. The methods and systems described herein use wireless backhaul, i.e., a radio access network (RAN) network and/or a base station as a backhaul to the repeater site(s). Repeater(s) can be installed within a footprint or wireless coverage area of a parent base station. The repeater(s) can extend the wireless coverage area and accordingly, increase offload opportunities. One or more repeater(s) can be installed within the wireless coverage area of the parent site.

In implementations, a parent base station can discover the repeater and repeater can discover the parent base station. After discovery, the parent base station and the repeater can undergo a pairing process, which basically locks the repeater to the parent base station. At this point, the repeater may have basic configuration such as an IP address and the ability to communicate with the parent base station. A repeater registrar can provide configuration and provisioning information to the repeater. The repeater registrar can register the repeater with the SAS and obtain a grant for transmission for the repeater.

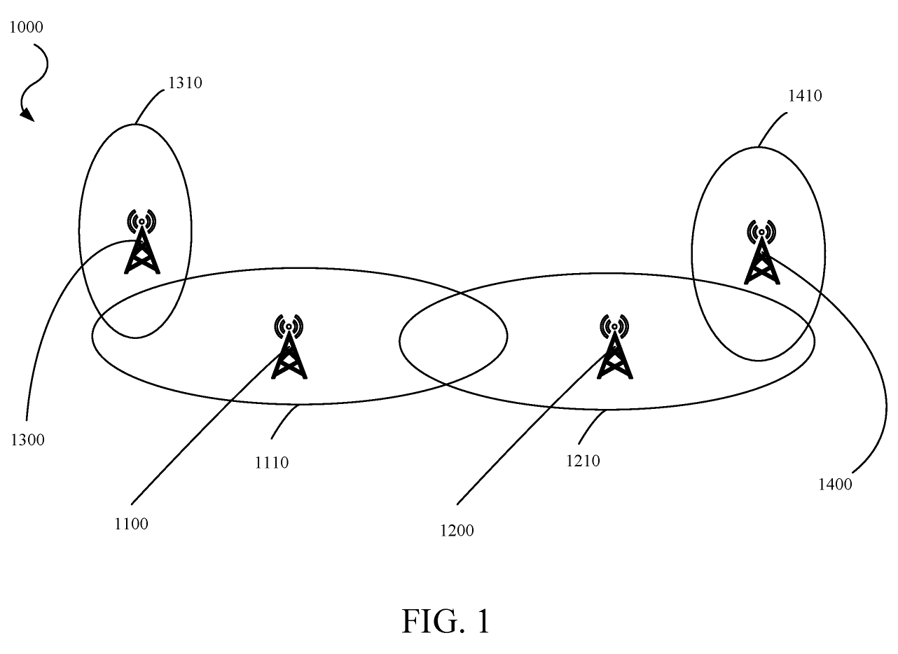

FIG. 1 is a diagram of an example of a wireless network 1000 in accordance with embodiments of this disclosure. The wireless network 1000 can implement any wireless technology including, but not limited to, third generation (3G), fourth generation (4G), and fifth generation (5G) wireless communications and/or networks, and CBRS or shared spectrum wireless technologies and/or networks. The number of components shown herein are illustrative and there may be more or less in the wireless network 1000. The wireless network 1000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

The wireless network 1000 can include, but is not limited to, a base station 1100 and a base station 1200. Each of the base stations 1100 and 1200 can support wireless communications via one or more of the 3G, the 4G, and the 5G wireless technologies and/or networks and via CBRS wireless technologies and/or networks. The base stations 1100 and 1200 can be, but is not limited to, a CBRS device (a CBSD), an access point, an access node, a gNodeB, a small cell base stations, a low-powered cellular radio access node, a small, low-power base station, and/or like device which enables radio communications access between a user device and other devices in wireless coverage areas or cells associated with the one or more base stations 1100 and 1200. In implementations, the base station 1100 can include, but is not limited to, a cell, footprint, and/or wireless coverage area 1110. In implementations, the base station 1200 can include, but is not limited to, a cell, footprint, and/or wireless coverage area 1210. In implementations, the wireless coverage area 1110 can overlap with the wireless coverage area 1210.

Repeater(s) can be installed within the wireless coverage area (as defined in this instance by the wireless coverage area 1110 and the wireless coverage area 1210) of the wireless network 1000 to increase the wireless coverage area of the wireless network 1000. In implementations, repeater(s) can be installed and powered on by installer and then the automated methods and systems described herein can discover, configure, and register the repeater(s). In these instances, the base stations 1100 and 1200, respectively, can act as wireless backhaul for the repeater(s). In a non-limiting illustration, repeater 1300 can be installed on the wireless coverage area 1110 of the base station 1100 and repeater 1400 can be installed on the wireless coverage area 1210 of the base station 1200. The repeater 1300 can include, but is not limited to, a cell, footprint, and/or wireless coverage area 1310. The repeater 1400 can include, but is not limited to, a cell, footprint, and/or wireless coverage area 1410. In these instances, the wireless coverage area of the wireless network 1000 is increased by the wireless coverage area 1310 and the wireless coverage area 1410. In implementations, the base station 1100, the base station 1200, the repeater 1300, and the repeater 1400 can be CSBDs.

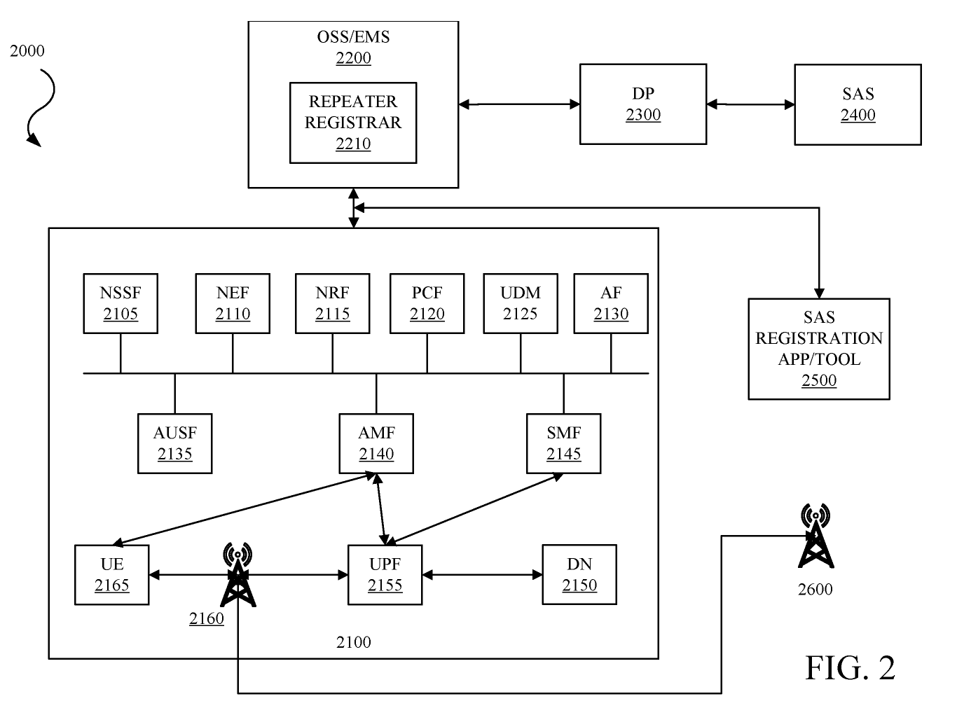

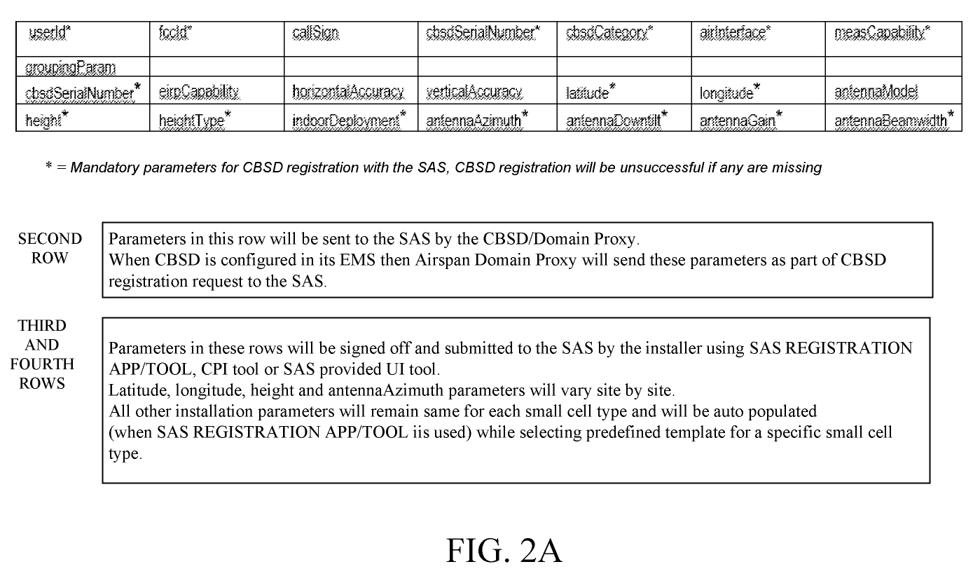

FIG. 2 is a diagram of an example wireless network architecture 2000. The wireless network architecture 2000 can include, but is not limited to, a core 2100, an operations support system (OSS) 2200, a domain proxy (DP) 2300, a spectrum access system (SAS) 2400, a SAS registration or installation tool 2500, and a repeater 2600. The wireless network architecture 2000 can implement any wireless technology including, but not limited to, third generation (3G), fourth generation (4G), and fifth generation (5G) wireless communications, and CBRS or shared spectrum wireless technologies. The number of components shown herein are illustrative and there may be more or less in the wireless network architecture 2000. The wireless network architecture 2000 and the components therein may include other elements which may be desirable or necessary to implement the devices, systems, and methods described herein. However, because such elements and steps are well known in the art, and because they do not facilitate a better understanding of the disclosed embodiments, a discussion of such elements and steps may not be provided herein.

The core 2100 can include various functional components to address mobility management, authentication, session management, and other related functions. In implementations, the core 2100 can include, but is not limited to, a Network Slice Selection Function (NSSF) 2105, a Network Exposure Function (NEF) 2110, a Network Repository Function (NRF) 2115, a Policy Control Function (PCF) 2120, a Unified Data Management (UDM) 2125, an Application Function (AF) 2130, an Authentication Server Function (AUSF) 2135, an Access and Mobility management Function (AMF) 2140, a Session Management Function (SMF) 2145, a Data Network (DN) 2150, a User Plane Function (UPF) 2155, and a Radio Access Network (RAN) or base station 2160 in communication with a User Equipment 2165. The core 2100 can function as described in the 3rd Generation Partnership Project (3GPP) specifications, which are incorporated herein by reference as if set forth herein. In implementations, the NSSF 2105 can handle network slice functions, the AUSF 2135 can handle authentication functions, the UDM 2125 can handle security credentials and store subscriber information for use by other functions, the AMF 2140 can handle control plane functions and connection and management mobility tasks, the SMF 2145 can handle calls and sessions, the PCF 2120 can handle processes to ensure that the user data traffic does not exceed the negotiated bearer(s) capacities, determine session times and/or usage, and determine charges based on session time and charging policy, the AF 2130 can control application(s) and provide charging and/or usage reports, the RAN or base station 2160 can handle access, the UPF 2155 can handle the user data, and the DN 2150 can act as a user data repository.

In implementations, the repeater 2600 and the base station 2160 can be an access point, an access node, or like device which enables radio communications access between mobile devices and other devices. In the instance that the base station 2160 uses or supports the CBRS spectrum, the base station can be, in part, a CBRS Device (CBSD), which has been granted or authorized CBRS spectrum by the SAS 2400. The base station 2160 can be part of a service provider system or multiple systems operator (MSO) which provides connectivity and content to user equipment, a mobile device, and like devices. In implementations, the repeater 2600 and the base station 2160 are CBSDs.

The repeater 2600 can be set up at a cell edge to help a distant mobile device get back to the base station 2160. The repeater 2600 can increase or augment the wireless coverage and/or increase the capacity of the wireless network. In the instance that repeater 2600 supports or uses the CBRS spectrum, the repeater 2600 needs to be registered with the SAS 2400. In implementations, the repeater 2600 can be registered with the SAS 2400 using the systems and methods described herein.

The user equipment and the mobile device can be, but is not limited to, Internet of Thing (IoT) devices, sensors, end user devices, cellular telephones, Internet Protocol(IP) devices, mobile computers, laptops, handheld computers, personal media devices, smartphones, notebooks, notepads, and the like can be provisioned for operation with a MSO, a MVNO, or other like service provider.

In implementations, the OSS 2200 can work with the SAS 2400 (via the DP 2300) and other components to configure, provision, and register a repeater, such as the repeater 2600, so that they can provide the extended wireless coverage from the base station 2160.

In implementations, the OSS 2200 can include a repeater registrar 2210, which can automatically configure, provision, and register a repeater, such as the repeater 2600. In implementations, the repeater registrar 2210 can be a standalone device and/or a third party in communication with the OSS 2200. In implementations, the repeater registrar 2210 can be integrated with the OSS 2200. In implementations, the repeater registrar 2210, which can be a controller, an engine, and/or server, can receive repeater information from a parent base station, such as the base station 2160. The repeater registrar 2210 can provide software and configuration information for the repeater. The repeater registrar 2210 can initiate provisioning of the repeater in response to the repeater. The repeater registrar 2210 can register the repeater with the SAS.

In implementations, the OSS 2200 and/or the repeater registrar 2210 can work with the core 2100, the SAS 2400, the SAS registration tool 2500, and other components to maintain information with respect to CBSDs (“CBSD information”) and repeater(s) (“repeater information”) comprising or in a wireless or CBRS network and provide the CBSD information and the repeater information to the core 2100. In implementations, the OSS 2200 and/or the repeater registrar 2210 can provide updated CBSD information and repeater information to the core 2100, as appropriate. The OSS 2200 and/or the repeater registrar 2210 can work with a wireless or CBSD network, the core 2100, the base station 2160 and other components to receive information when a repeater has been discovered (discovery event) and initiate configuring and provisioning of the repeater. The OSS 2200 and/or the repeater registrar 2210 can work with a wireless or CBSD network, the core 2100, the base station 2160, the SAS 2400, and other components as to when a repeater has registered, received a grant, and/or a heartbeat response (collectively “registration information” or “registration event”) and provide the registration information to the core 2100.

The SAS 2400 can enable access to the CBRS spectrum and dynamically manages the spectrum for optimal use, efficiency, and compliance with CBRS rules. The SAS 2400 communicates with each base station (which can be a CBSD) for registration, grant allocation/deallocation and interference management. The SAS 2400 can perform interference analysis based on power measurements received from mobile device(s) and make allocation and deallocation decisions based on the interference. The SAS 2400 may be operated be a commercial, federal entity, or some combination thereof.

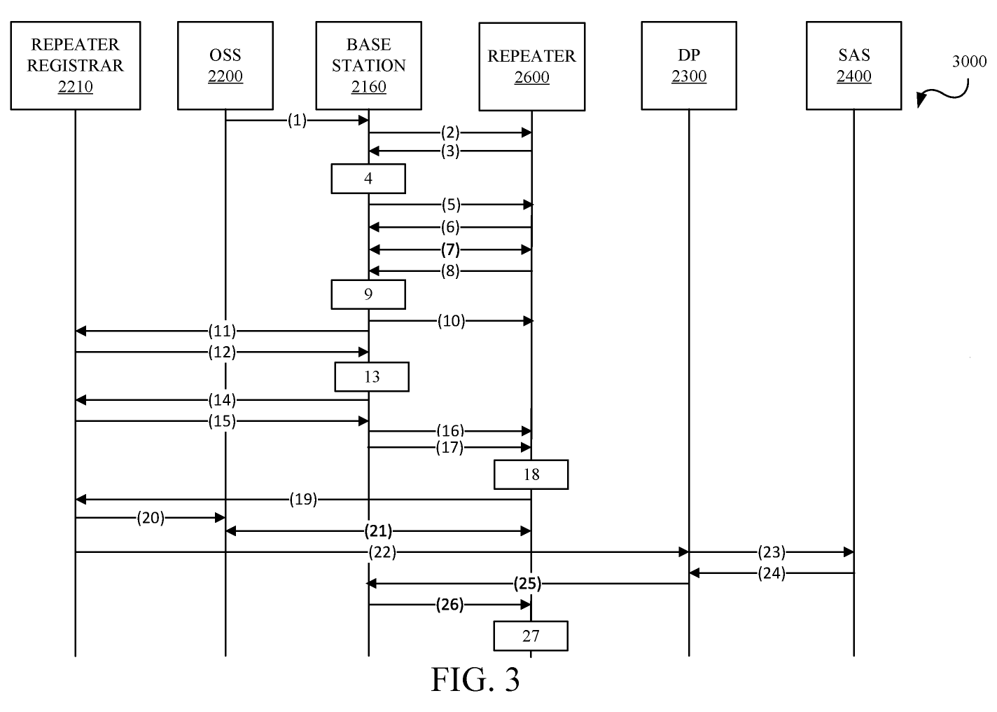

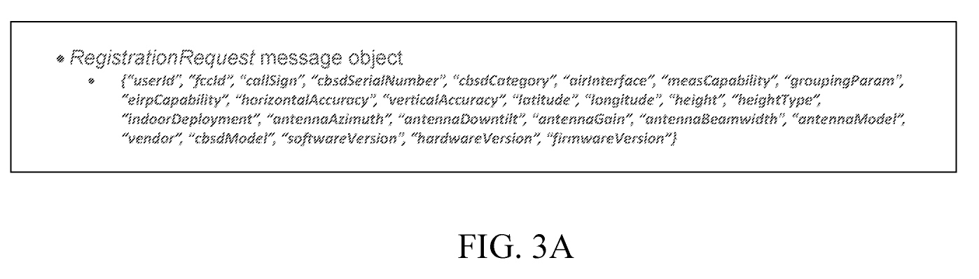

FIG. 3 is a flowchart of an example method 3000 for automated repeater registration flow in accordance with the teachings described herein. In implementations, the wireless network 1000 and components therein and the wireless network architecture 2000 and components therein can use the method 3000 for automated repeater registration.

An installer can install the repeater 2600 in a wireless coverage area of the base station 2160. In implementations, the placement of the repeater 2600 can be at an edge of the wireless coverage area to provide an extended wireless coverage area. The repeater 2600 is placed and powered on. Repeater information can be provided to the OSS 2200 via the SAS registration tool 2500. The repeater information can include, but is not limited to, a serial number, a identifier (ID) number, SAS registration parameters, and the like. The SAS registration parameters can be as shown in FIG. 2A. Some of the repeater information can be input by an installer via the SAS registration or installation tool 2500. Some of the parameters are automatically calculated e.g., location (latitude/longitude), height, etc. Some of the parameters are specific to the CBSR device (CBSD) e.g., FCC ID, serial number, beamwidth, antenna gain, category, etc. The SAS registration parameters are applicable for any CBRS device (CBSD). A remaining process can be automated as described herein.

The OSS 2200 can send the repeater information to the base station 2160 once the repeater 2600 is installed and powered on (1). The base station 2160 can send a broadcast message which can contain information that repeater 2600 can use to attach to the base station 2160 (2). In a non-limiting illustration, the message and information can include, but is not limited to, Synchronization Signal Block (SSB), Physical Broadcast Channel (PBCH), System Information Block (SIB), and like messages and information. The repeater 2600 can initiate a random access channel (RACH) procedure to identify itself using its serial number and ID number (3) in response to receiving the broadcast message. The repeater 2600 can use low power (i.e., operate as or at a CBSD type or category A) to initiate this process and as such, a SAS grant is not needed at this time.

The base station 2160 can review and decode the message preamble from the repeater 2600 (4). The base station 2160 can acknowledge receipt of the preamble message and request information from the repeater 2600 to ensure that it’s the right repeater (5). The requested information can include, but is not limited to, security certificates, serial number of the radio, and software information. The base station 2160 can provide the requested information (6). The base station 2160 and the repeater 2600 can perform a handshake process to establish a secure connection (7). The base station 2160 can request an IP address (8). The base station 2160 can assign an IP address from a pool of IP addresses (9). The base station 2160 can send the IP address to the repeater (10). The IP address can be used for further communications at layer 3 level with the rest of the core network elements and enable the repeater 2600 to have communications for the rest of the automated processes, i.e., configuration and provisioning. Events (1) through (10) can be referred to as the discovery stage and is done automatically once the repeater 2600 is installed and powered on.

Once the discovery stage is complete, the base station 2160 can provide the repeater information to the repeater registrar 2210 and request the latest or up-to-date software download and configuration information (collectively “configuration information”) for the repeater 2600 (11). The repeater registrar 2210 can provide details for the requested configuration information to the base station 2160 (12). In response to the received details, the base station 2160 can configure itself for receiving the configuration information (13). This can include, but is not limited to, reserving memory, scheduling process time, and the like. The base station 2160 can request the configuration information from the repeater registrar 2210 (14). The repeater registrar 2210 can send the configuration information, i.e., a software download, configuration file, channel to be used for backhaul, and user equipment connectivity information (15). The base station 2160 can send the software download and the configuration file to the repeater 2600 (16) and (17). The repeater 2600 can run or execute the software download and the configuration file (18). The repeater 2600 can request provisioning from the repeater registrar 2210 after updating with the configuration information is complete (19). The repeater registrar 2210 can provide the repeater information to the OSS 2200 to initiate provisioning (20). The OSS 2200 can establish connectivity with the repeater 2600 via the wireless backhaul, i.e., the base station 2160, to complete provisioning of the repeater 2600 (21). Events (11) through (21) can be referred to as the configuration and provisioning stage and is done automatically once the discovery stage is completed.

The repeater registrar 2210 can register the repeater 2600 with the SAS 2400 via the DP 2300 (22) and (23). Registration can be done using the repeater information, configuration information, and the SAS registration parameters shown in FIG. 2A. The repeater registrar 2210 can send a registration request via the DP 2300. The registration request can include, but is not limited to, a registration request object as shown in FIG. 3A. The SAS 2400 can send a registration message, which can include, but is not limited, to a grant and a heartbeat (24). The DP 2300 can forward the registration message to the base station 2160 (25), which in turn can forward it to the repeater 2600 (26). The repeater 2600 can then start transmitting and accept traffic (27). Events (22) through (27) can be referred to as the registration stage and is done automatically once the configuration and provisioning stage is completed.

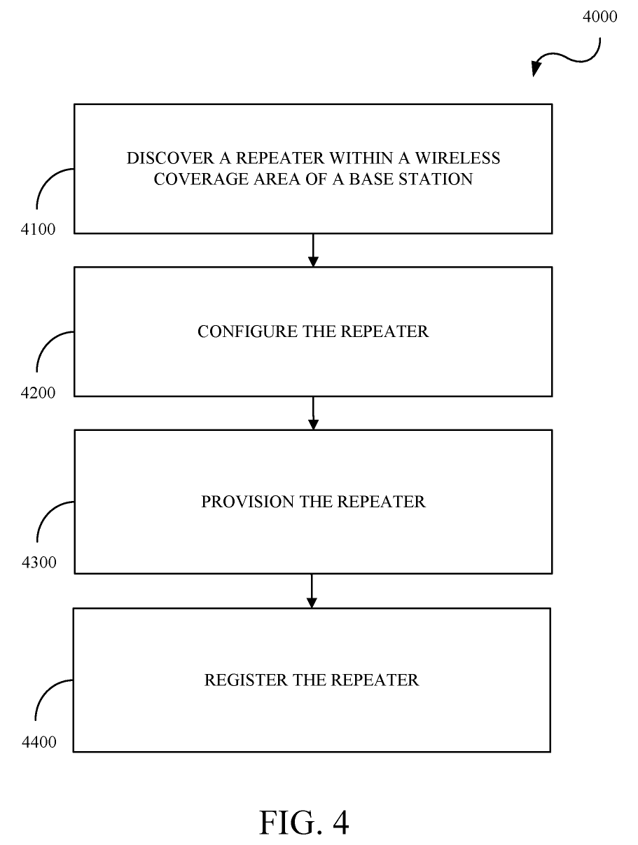

FIG. 4 is a flowchart of an example method 4000 for automated repeater registration in accordance with the teachings described herein. The method 4000 includes: discovering 4100 a repeater within a wireless coverage area of a base station; configuring 4200 the repeater; provisioning 4300 the repeater; and registering 4400 the repeater. The method 4000 can be implemented, for example, in or by components described with respect to FIGS. 1-3 and in conjunction with any of the flows described with respect to FIG. 3. as appropriate and applicable.

The method 4000 includes discovering 4100 a repeater within a wireless coverage area of a base station. A repeater, such as a CBSD, can be installed and powered on in a wireless coverage area of a base station. In implementations, the base station can be a CBSD. The base station and the repeater can mutually discover each other’s presence. In view of the discovery, the base station and repeater can perform an attachment process to attach the repeater to the base station.

The method 4000 includes configuring 4200 the repeater. Once attached and secure communications have been established, the base station can determine from a registrar what are the latest versions of configuration information for the repeater. This can include, but is not limited to, software and configuration versions. If updated configuration information is needed, the base station can prepare the base station for scheduling and receiving the updated configuration information. The base station can send the updated configuration information to the repeater, which in turn can update itself by running the updated configuration information.

The method 4000 includes provisioning 4300 the repeater. Once the repeater has updated itself to the latest configuration information or applied the configuration information, the repeater can request provisioning from the registrar. The registrar can message the OSS to initiate provisioning via the base station as a wireless backhaul. In implementations, provisioning can refer to provisioning and activation. Provisioning can include multiple processes. In implementations, provisioning can include provisioning to the backhaul network and to the EMS/OSS. In implementations, provisioning can include provisioning a base station, repeater, and/or similar devices into the backbone of the network so that the devices can reach the OSS and wireless core network. In this instance, the device is a repeater and the base station is a main, donor, and/or parent base station (collectively “parent”). The parent base station can act as a last mile backhaul after the wired backhaul. The parent base station can get the repeater an IP address, billing information, and other information and provide reachability to the core via the backhaul network. After this is complete, the repeater can be provisioned on the OSS.

The method 4000 includes registering 4400 the repeater. Once the provisioning is complete, the registrar can register the repeater with the SAS. The registered repeater can then conduct traffic.

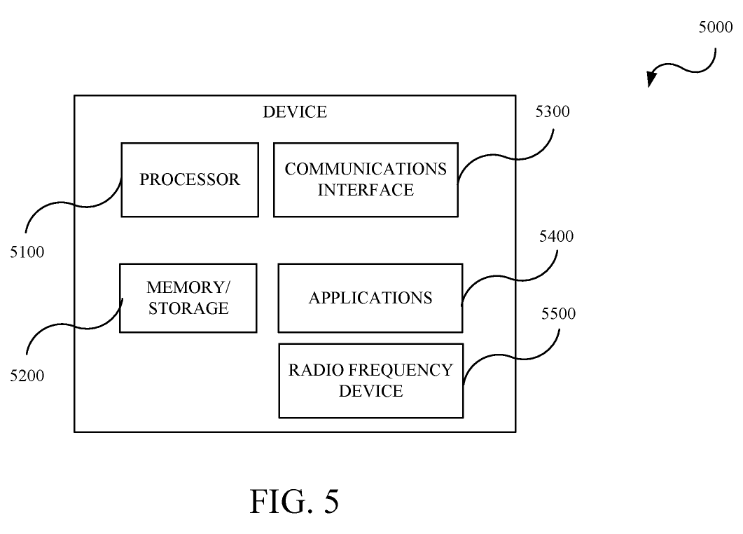

FIG. 5 is a block diagram of an example of a device 5000 in accordance with the teachings described herein. The device 5000 may include, but is not limited to, a processor 5100, a memory/storage 5200, a communications interface 5300, applications 5400, and, if needed, a radio frequency device 5500. The device 5000 may include or implement, for example, the system and components described with respect to FIGS. 1-3 and the implement the methods of FIG. 3 and 4. The applicable or appropriate flows, techniques, or methods described herein may be stored in the memory/storage 5200 and executed by the processor 5100 in cooperation with the memory/storage 5200, the communications interface 5300, the applications 5400, and the radio frequency device 5500 (when applicable), as appropriate. The device 5000 may include other elements which may be desirable or necessary to implement the devices, systems, and methods described herein. However, because such elements and steps do not facilitate a better understanding of the disclosed embodiments, a discussion of such elements and steps may not be provided herein.

Described herein is a method for automatic discovery, configuration, and registration of Citizens Broadband Radio Service (CBRS) repeaters. In implementations, a method includes discovering, by a base station, the repeater within a wireless coverage area of a base station, where the repeater is configured to extend the wireless coverage area of the base station, configuring, by a repeater register via the base station, the repeater with configuration information, provisioning, by an operations support system, the repeater upon the repeater completing application of the configuration information, and registering, by the repeater register, the repeater with a spectrum access system to enable repeater transmissions upon completion of the provisioning, where the base station performs as a wireless backhaul.

In implementations, the discovering, the configuring, the provisioning, and the registering are automatically executed in response to discovering the repeater by the base station. In implementations, the discovering further includes broadcasting, by the base station, an attachment message, and receiving, by the base station from the repeater, repeater information in response to the attachment message. In implementations, the discovering further includes receiving, by the base station from the repeater, security information in response to a request from the base station, and establishing a secure connection between the base station and the repeater. In implementations, the discovering further includes sending, by the base station to the repeater, an IP address in response to a request from the repeater. In implementations, the configuring further includes providing, by the repeater register to the base station, the configuration information for the repeater in response to a request from the base station. In implementations, the configuration information includes software download, configuration file, channel to be used for backhaul, and user equipment connectivity information. In implementations, the method further includes notifying, the operations support system, to initiate the provisioning of the repeater when the repeater register receives a request from the repeater; and establishing a connection between the operations support system and the repeater via the base station as the wireless backhaul.

Described herein is a system for automatic discovery, configuration, and registration of Citizens Broadband Radio Service (CBRS) repeaters. In implementations, a system includes a Citizens Broadband Radio Service (CBRS) device configured to detect a CBRS extender in a wireless coverage area of the CBRS device, and establish a secure channel with the CBRS extender; and a registrar configured to automatically provide the CBRS extender with configuration information in response to a request from the CBRS device, automatically initiate provisioning of the CBRS extender upon configuration completion, and automatically register the CBRS extender with a spectrum access system to enable transmissions upon provisioning completion, where the CBRS device is configured as a wireless backhaul between the CBRS extender and the registrar and the CBRS extender is configured to extend the wireless coverage area of the CBRS device.

In implementations, the CBRS device is further configured to receive identification information from the CBRS extender in response to attachment broadcast messages sent by the CBRS device. In implementations, the CBRS device is further configured to receive security credentials from the CBRS extender to establish the secure channel. In implementations, the CBRS device is further configured to provide an IP address to the CBRS extender. In implementations, the configuration information includes software download, configuration file, channel to be used for backhaul, and user equipment connectivity information. In implementations, the system further includes an operations support system, wherein the registrar is further configured to message an operations support system to initiate the provisioning of the CBRS extender, and the operations support system configured to establish a connection with the CBRS extender via the CBRS device as the wireless backhaul. Described herein is a method for automatically registering a shared spectrum relay using a Citizens Broadband Radio Service (CBRS) spectrum. In implementations, the method includes detecting, by a base station, a shared spectrum relay in a cell of the base station, establishing, by the base station, a secure channel with the shared spectrum relay, automatically providing, by a registration controller, configuration information to the shared spectrum relay, wherein the base station is wireless backhaul between the shared spectrum relay and the registration controller, automatically initiating, by the registration controller, provisioning of the shared spectrum relay upon configuration completion, and automatically registering, by the registration controller, the shared spectrum relay with a spectrum access system upon provisioning completion, where the shared spectrum relay extends the cell of the base station.

In implementations, the method further includes receiving, by the base station, identification information from the shared spectrum relay in response to attachment broadcast messages sent by the base station. In implementations, the method further includes receiving, by the base station, security credentials from the shared spectrum relay to establish the secure channel. In implementations, the method further includes providing, by the registration controller, an IP address to the shared spectrum relay. In implementations, the configuration information includes software download, configuration file, channel to be used for backhaul, and user equipment connectivity information. In implementations, the method further includes messaging, by the registration controller, an operations support system to initiate the provisioning of the shared spectrum relay, and establishing, by the operations support system, a connection with the shared spectrum relay via the base station as the wireless backhaul.

Although some teachings and/or embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to teachings and/or embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various teachings and/or embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain teachings and/or embodiments, it is to be understood that the disclosure is not to be limited to the disclosed teachings and/or embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for automatically registering a repeater using a Citizens Broadband Radio Service (CBRS) spectrum, the method comprising:
discovering, by a base station, the repeater within a wireless coverage area of a base station, wherein the repeater is configured to extend the wireless coverage area of the base station;
configuring, by a repeater register via the base station, the repeater with configuration information;
provisioning, by an operations support system, the repeater upon the repeater completing application of the configuration information; and
registering, by the repeater register, the repeater with a spectrum access system to enable repeater transmissions upon completion of the provisioning,
wherein the base station performs as a wireless backhaul.

2. The method of claim 1, wherein the discovering, the configuring, the provisioning, and the registering are automatically executed in response to discovering the repeater by the base station.

3. The method of claim 1, wherein the discovering further comprising:
broadcasting, by the base station, an attachment message; and
receiving, by the base station from the repeater, repeater information in response to the attachment message.

4. The method of claim 1, wherein the discovering further comprising:
receiving, by the base station from the repeater, security information in response to a request from the base station; and
establishing a secure connection between the base station and the repeater.

5. The method of claim 1, wherein the discovering further comprising:
sending, by the base station to the repeater, an IP address in response to a request from the repeater.

6. The method of claim 1, wherein the configuring further comprising:
providing, by the repeater register to the base station, the configuration information for the repeater in response to a request from the base station.

7. The method of claim 6, wherein the configuration information includes software download, configuration file, channel to be used for backhaul, and user equipment connectivity information.

8. The method of claim 1, further comprising:
notifying, the operations support system, to initiate the provisioning of the repeater when the repeater register receives a request from the repeater; and
establishing a connection between the operations support system and the repeater via the base station as the wireless backhaul.

9. A system, comprising:
a Citizens Broadband Radio Service (CBRS) device configured to:
detect a CBRS extender in a wireless coverage area of the CBRS device; and
establish a secure channel with the CBRS extender; and
a registrar configured to:
automatically provide the CBRS extender with configuration information in response to a request from the CBRS device;
automatically initiate provisioning of the CBRS extender upon configuration completion; and
automatically register the CBRS extender with a spectrum access system to enable transmissions upon provisioning completion,
wherein the CBRS device is configured as a wireless backhaul between the CBRS extender and the registrar and the CBRS extender is configured to extend the wireless coverage area of the CBRS device.

10. The system of claim 9, wherein the CBRS device is further configured to:
receive identification information from the CBRS extender in response to attachment broadcast messages sent by the CBRS device.

11. The system of claim 9, wherein the CBRS device is further configured to:
receive security credentials from the CBRS extender to establish the secure channel.

12. The system of claim 9, wherein the CBRS device is further configured to:
provide an IP address to the CBRS extender.

13. The system of claim 9, wherein the configuration information includes software download, configuration file, channel to be used for backhaul, and user equipment connectivity information.

14. The system of claim 9, further comprising:
an operations support system, wherein the registrar is further configured to message an operations support system to initiate the provisioning of the CBRS extender; and
the operations support system configured to establish a connection with the CBRS extender via the CBRS device as the wireless backhaul.

15. A method for automatically registering a shared spectrum relay using a Citizens Broadband Radio Service (CBRS) spectrum, the method comprising:
detecting, by a base station, a shared spectrum relay in a cell of the base station;
establishing, by the base station, a secure channel with the shared spectrum relay;
automatically providing, by a registration controller, configuration information to the shared spectrum relay, wherein the base station is wireless backhaul between the shared spectrum relay and the registration controller;
automatically initiating, by the registration controller, provisioning of the shared spectrum relay upon configuration completion; and
automatically registering, by the registration controller, the shared spectrum relay with a spectrum access system upon provisioning completion, wherein the shared spectrum relay extends the cell of the base station.

16. The method of claim 15, further comprising:
receiving, by the base station, identification information from the shared spectrum relay in response to attachment broadcast messages sent by the base station.

17. The method of claim 15, further comprising:
receiving, by the base station, security credentials from the shared spectrum relay to establish the secure channel.

18. The method of claim 15, further comprising:
providing, by the registration controller, an IP address to the shared spectrum relay.

19. The method of claim 15, wherein the configuration information includes software download, configuration file, channel to be used for backhaul, and user equipment connectivity information.

20. The method of claim 15, further comprising:
messaging, by the registration controller, an operations support system to initiate the provisioning of the shared spectrum relay; and
establishing, by the operations support system, a connection with the shared spectrum relay via the base station as the wireless backhaul.
